(19) United States
(12) Patent Application Publication
(10) Pub. No.: US 2017/0316217 A1
(43) Pub. Date: Nov. 2, 2017

(54) MULTI-FACTOR AUTHENTICATION BASED CONTENT MANAGEMENT

(71) Applicant: Hewlett-Packard Development Company, L.P., Houston, TX (US)

(72) Inventors: Kenneth K Smith, Boise (HN); Scott White, Boise, ID (US); Timothy P Blair, Boise, ID (US); Kristofer Erik Metz, Meridian, ID (US)

(21) Appl. No.: 15/521,865

(22) PCT Filed: Oct. 31, 2014
(86) PCT No.: PCT/US2014/063491

§ 371 Date: Apr. 25, 2017

(51) Int. Cl. G06F 21/60; H04L 9/32; H04L 29/06

(52) U.S. Cl. CPC G06F 21/608; H04L 63/107; H04L 9/3263; H04L 2463/082

(57) ABSTRACT

According to an example, multi-factor authentication based content management may include receiving a document viewing device certificate of a document viewing device, where the document viewing device certificate may enable the document viewing device to view an encrypted document. A determination may be made as to whether to permit the document viewing device to modify or print the encrypted document based on the document viewing device certificate. In response to a determination to permit the document viewing device to modify or print the encrypted document based on the document viewing device certificate, an authentication apparatus certificate that enables the document viewing device to modify or print the encrypted document may be forwarded to the document viewing device.

### BACKGROUND

A recipient of encrypted content, such as an encrypted electronic message, may utilize a key to decode the encrypted content, and thereafter view the decrypted content.

### BRIEF DESCRIPTION OF DRAWINGS

Features of the present disclosure are illustrated by way of example and not limited in the following figure(s), in which like numerals indicate like elements, in which:

FIG. 1A illustrates an architecture of a multi-factor authentication based content management apparatus, according to an example of the present disclosure;

FIG. 1B illustrates an environment to illustrate operation of the multi-factor authentication based content management apparatus of FIG. 1A, according to an example of the present disclosure;

FIG. 2 illustrates further details of the environment to illustrate operation of the multi-factor authentication based content management apparatus of FIG. 1A, according to an example of the present disclosure;

FIG. 3 illustrates a method for multi-factor authentication based content management, according to an example of the present disclosure;

FIG. 4 illustrates further details of the method for multi-factor authentication based content management, according to an example of the present disclosure;

FIG. 5 illustrates further details of the method for multi-factor authentication based content management, according to an example of the present disclosure; and

FIG. 6 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Content management may include processes and technologies that support the collection, management, and publishing of information in any form or medium. When a sender of an electronic message is to securely communicate with a recipient of the electronic message, a digital certificate may be obtained from a certificate authority, attached to the electronic message, and used for security purposes. The digital certificate may be used to ensure that a public key contained in the digital certificate belongs to the sender to which the certificate was issued. The recipient of an encrypted electronic message may also use the certificate authority's public key to decode the digital certificate attached to the electronic message, verify that the digital certificate is issued by the certificate authority, and then obtain the sender's public key and identification information held within the digital certificate. The decoded electronic message may then be viewed, modified, and/or printed by the recipient of the encrypted electronic message. However, another form of verification may be needed to ensure that the recipient of the encrypted electronic message has the authority to view and/or print the encrypted electronic message. Moreover, actions taken with respect to the encrypted electronic message may also need to be tracked, for example, for compliance with regulations. For example, actions such as viewing, printing, and/or modification with respect to the encrypted electronic message may need to be tracked.

According to examples, a multi-factor authentication based content management apparatus (hereinafter also referred to as an authentication apparatus) and a method for multi-factor authentication based content management are disclosed herein. Generally, the apparatus and method disclosed herein provide for the control (e.g., authorization or denial of authorization) with respect to documents and information generally that should not be viewed, modified, printed, and/or otherwise utilized. The apparatus and method disclosed herein provide for the storage and tracking of information related to when, where, and who has viewed, modified, and/or printed an electronic document. For example, based on an indication that an electronic document has been printed, an auditing trail may be used to determine when, where, and who has printed the electronic document.

According to an example, multi-factor authentication based content management may include receiving a document viewing device certificate of a document viewing device that uses the document viewing device certificate to view an encrypted document. According to an example, the document viewing device certificate may provide the document viewing device limited permission to view the encrypted document.

According to an example, the document viewing device may be disposed at or less than a predetermined distance away from the authentication apparatus without contact with the authentication apparatus. That is, the authentication apparatus may communicate with the document viewing device without contact with the document viewing device. The predetermined distance may be determined based on received signal strength indicator (RSSI) values, device transmit power levels for the apparatus and/or the document viewing device, and/or received channel power indicator (RCPI) values. Additionally or alternatively, with respect to the predetermined distance, other communication metrics may be communicated to the document viewing device. The predetermined distance may also reference a signed geo-location value, indoor location value, and/or any other number of distance measurement techniques including direct radial distance measurement from a single point, triangulation distance estimation based on three or more signal sources, and/or distance estimation based on a signed predetermined location beacon.

According to an example, the authentication apparatus may be a smart badge, an electronic earring, a smart watch, or another such device that is wearable by a user, disposable in a user's pocket, held in a user's hand, or otherwise brought into the vicinity of the document viewing device to send and receive information (e.g., the encrypted document, the decrypted document, etc.) as described herein. Thus, the authentication apparatus may effectively authenticate the user that is wearing the authentication apparatus. The document viewing device may be smartphone, a tablet, a personal computer (PC), a printing device, or other such devices. The document viewing device may receive the encrypted document from a document repository that stores encrypted documents.

According to an example, for the apparatus and method disclosed herein, a determination may be made as to whether to permit the document viewing device to modify or print the encrypted document based on the document viewing device certificate. In response to a determination to permit the document viewing device to modify or print the encrypted document based on the document viewing device certificate, the encrypted document may be decrypted by using a key (e.g., a decryption key, or a secret key that is used for encryption and decryption). In response to the determination to permit the document viewing device to modify or print the encrypted document based on the document viewing device certificate, the decrypted document may be forwarded to the document viewing device for viewing, modification, and/or printing.

Alternatively or additionally, in response to a determination to permit the document viewing device to modify or print the encrypted document based on the document viewing device certificate, an authentication apparatus certificate that enables the document viewing device to modify or print the encrypted document may be forwarded to the document viewing device.

A certificate storage module of the multi-factor authentication based content management apparatus may utilize a certificate storage repository to store the document viewing device certificate and the authentication apparatus certificate. Further, as described herein, the certificate storage module may utilize the certificate storage repository to store a printing device certificate that is related to a printing device that is used to print the decrypted document.

An event history tracking module may record an event history related to the encrypted document based on the storing of the certificates, and the viewing, modification, and/or printing of the decrypted document. According to an example, the event history may be related to the encrypted document based on an identification of the document viewing device based on the stored document viewing device certificate, an identification of the authentication apparatus based on the stored authentication apparatus certificate, and the viewing, modification, and/or printing of the encrypted document.

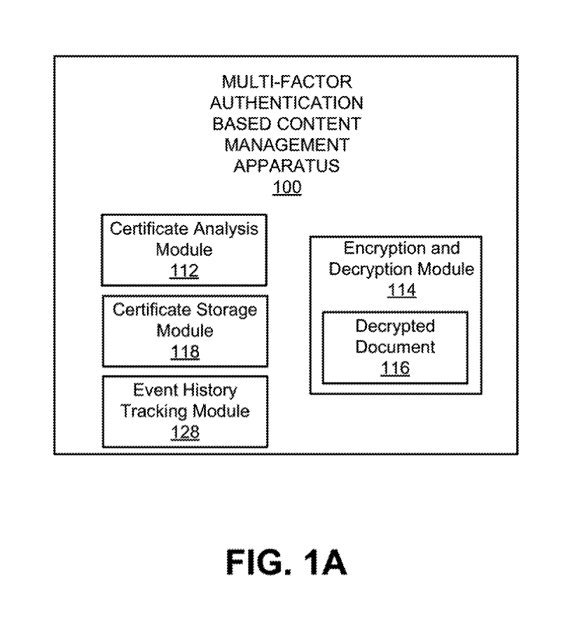

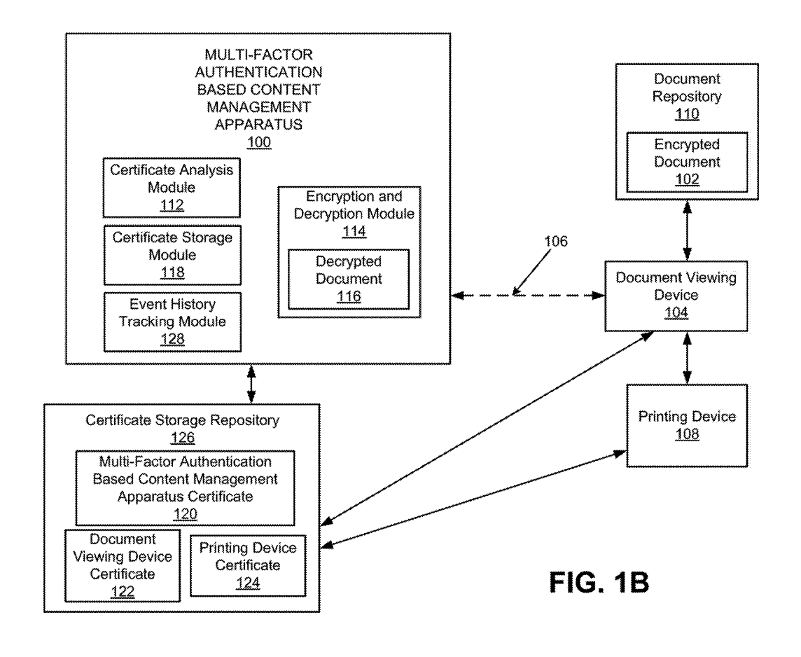

FIG. 1A illustrates an architecture of a multi-factor authentication based content management apparatus 100 (hereinafter also referred to as “apparatus 100”), according to an example of the present disclosure. FIG. 1B illustrates an environment to illustrate operation of the apparatus 100 of FIG. 1A, according to an example of the present disclosure. Referring to FIGS. 1A and 1B, the apparatus 100 may receive an encrypted document 102 from a document viewing device 104 when the apparatus 100 is disposed at or less than a predetermined distance 106 away from the document viewing device 104 without contact with the document viewing device 104. The predetermined distance 106 may be based on a communication capability of the apparatus 100, which may be relatively low powered device that provides for encryption and decryption related to the encrypted document 102, and implementation of the certificate analysis, certificate storage, and event history tracking functionality as disclosed herein. According to an example, the apparatus 100 may receive the encrypted document 102 from the document viewing device 104 when the apparatus 100 is contacted to the document viewing device 104, or otherwise communicatively engaged with the document viewing device 104.

According to an example, the encrypted document 102 may be encrypted so as to be viewed on the document viewing device 104, but may not be printable by the document viewing device 104, absent decryption of the encrypted document 102. According to an example, the encrypted document 102 may be encrypted so as to be received by the document viewing device 104, but may not be viewable on or printable by the document viewing device 104, absent decryption of the encrypted document 102.

According to an example, the apparatus 100 may be a smart badge, an electronic earring, a smart watch, etc., that is wearable by a user, disposable in a user's pocket, held in a user's hand, or otherwise brought into the vicinity of the document viewing device 104 to communicate with the document viewing device 104 as described herein. Generally, the apparatus 100 may be a low powered device that provides for encryption and/or decryption of the encrypted document 102. The apparatus 100 may include a location beacon, or other such technology to transmit a location thereof to the document viewing device 104, and/or for recording the location thereof with respect to tracking a history of the encrypted document 102 as described herein. The apparatus 100 may also provide for authentication of the document viewing device 104 and/or the user associated with the apparatus 100 for performing various operations (e.g., viewing, modifying, and/or printing) related to a document.

For the example of FIGS. 1A and 1B, the document viewing device 104 may be a smartphone, a tablet, a PC, or another such device that is to print the document using the printing device 108. According to an example, the document viewing device 104 may include communication capability such that when the apparatus 100 is disposed at or less than the predetermined distance 106 away from the document viewing device 104 without contact with the document viewing device 104, the encrypted document 102 may be forwarded to the apparatus 100 for decryption. Alternatively or additionally, a header related to the encrypted document 102 may be forwarded to the apparatus 100 for decryption of the encrypted document 102 upon return of the decrypted header to the document viewing device 104, and/or for providing the document viewing device 104 with the authority to decrypt, view, modify, and/or print the document.

According to an example, the document viewing device 104 may include communication capability such that when the apparatus 100 is contacted with or otherwise communicatively engaged with the document viewing device 104, the encrypted document 102 may be forwarded to the apparatus 100 for decryption.

The document viewing device 104 may receive the encrypted document 102 from a document repository 110. The document repository 110 may maintain a plurality of documents that are to be managed by the apparatus 100, including the encrypted document 102.

A certificate analysis module 112 of the apparatus 100 may determine whether to approve or disapprove a certificate (e.g., a document viewing device certificate 122 as described herein) related to the document viewing device 104. For example, as described herein, with respect to approval or disapproval of a certificate, the certificate analysis module 112 may evaluate a certificate (e.g., a digital certificate) of the document viewing device 104, and if the certificate is determined to be authentic, the certificate analysis module 112 may approve the certificate related to the document viewing device 104. Based on the approval of the certificate related to the document viewing device 104, the certificate analysis module 112 may authenticate the document viewing device 104. Based on the authentication of the document viewing device 104, the certificate analysis module 112 may permit the document viewing device 104, for example, to modify or print the encrypted document 102 based on the document viewing device certificate 122.

In response to a determination to approve the certificate related to the document viewing device 104, an encryption and decryption module 114 may decrypt the encrypted document 102. According to an example, the encryption and decryption module 114 may use a decryption key to decrypt the encrypted document 102, to thus generate a decrypted document 116. According to an example, the encryption and decryption module 114 may use a secret key that is specific to the apparatus 100 to encrypt and decrypt the encrypted document 102.

In response to the determination to approve the certificate related to the document viewing device 104, the decrypted document 116 may be forwarded to the document viewing device 104 for viewing, modification, and/or printing. According to an example, the decrypted document 116 may be forwarded to the document viewing device 104 for viewing, modification, and/or printing based on the capabilities of the document viewing device 104, and the authorization associated with the certificates of the apparatus 100, the document viewing device 104, the printing device 108, and/or the document repository 110.

According to an example, in response to a determination to approve the certificate related to the document viewing device 104, an authentication apparatus certificate (e.g., a multi-factor authentication based content management apparatus certificate 120 as described herein) that is to be used by the document viewing device 104 to modify or print the encrypted document 102 may be forwarded to the document viewing device 104.

A certificate storage module 118 may provide for the storage of certificates (e.g., the multi-factor authentication based content management apparatus certificate 120, the document viewing device certificate 122, and a printing device certificate 124) related to the apparatus 100, the document viewing device 104, and the printing device 108 in a certificate storage repository 126. A certificate associated with the document repository 110 may also be stored in the certificate storage repository 126. Thus, the apparatus 100, the document viewing device 104, and the printing device 108 may be considered as secure devices that each includes respective certificates associated therewith for authorized communication with each other. According to an example, the certificates associated with the apparatus 100, the document viewing device 104, and the printing device 108 may be digital certificates. In this manner, communication between the apparatus 100, the document viewing device 104, and the printing device 108 may be based on an assessment of the certificates associated with each respective device. The multi-factor authentication based content management apparatus certificate 120 may also serve as a key to provide for viewing, modification, and/or printing of the encrypted document 102. Further, storage of the multi-factor authentication based content management apparatus certificate 120, the document viewing device certificate 122, and the printing device certificate 124 may provide for association of these certificates with the particular decrypted document 116. In this manner, the identities of the particular devices that are encountered by a particular document may be associated with the particular document for subsequent analysis.

An event history tracking module 128 may record an event history related to the document (e.g., the encrypted document 102 and/or the decrypted document 116) based on the storing of the certificates and the viewing, modification, and/or printing of the document. For example, when the decrypted document 116 is viewed, modified, and/or printed, the certificate storage module 118 may be notified of the event related to the viewing, modification, and/or printing. Upon notification of the event, the certificate storage module 118 may store the multi-factor authentication based content management apparatus certificate 120, the document viewing device certificate 122, and the printing device certificate 124 in the certificate storage repository 126. Further, the event history tracking module 128 may store information related to whether the decrypted document 116 has been viewed, modified, and/or printed, and that the decrypted document 116 should now be further tracked.

Once the decrypted document 116 is viewed, modified, and/or printed, the encryption and decryption module 114 may encrypt the decrypted document 116, and forward the encrypted document 102 to the document viewing device 104 to return to the document repository 110.

The modules and other elements of the apparatus 100 may be machine readable instructions stored on a non-transitory computer readable medium. In this regard, the apparatus 100 may include or be a non-transitory computer readable medium. In addition, or alternatively, the modules and other elements of the apparatus 100 may be hardware or a combination of machine readable instructions and hardware.

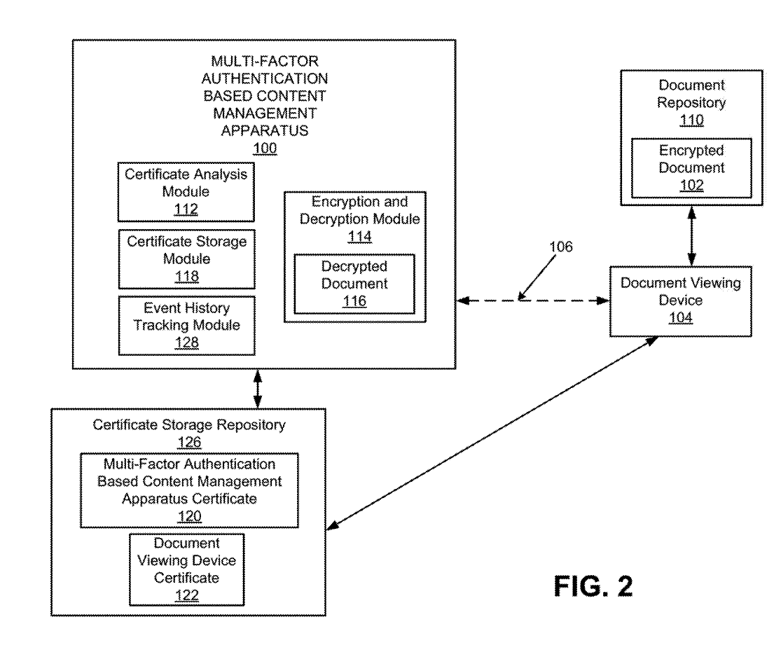

FIG. 2 illustrates further details of the environment to illustrate operation of the apparatus 100, according to an example of the present disclosure. Referring to FIGS. 1A and 2, according to an example, the document viewing device 104 may be a printing device to print the document. In this example, the document viewing device 104 may print the encrypted document 102 once the encrypted document 102 has been decrypted, without having to use the printing device 108 as shown in FIG. 1B.

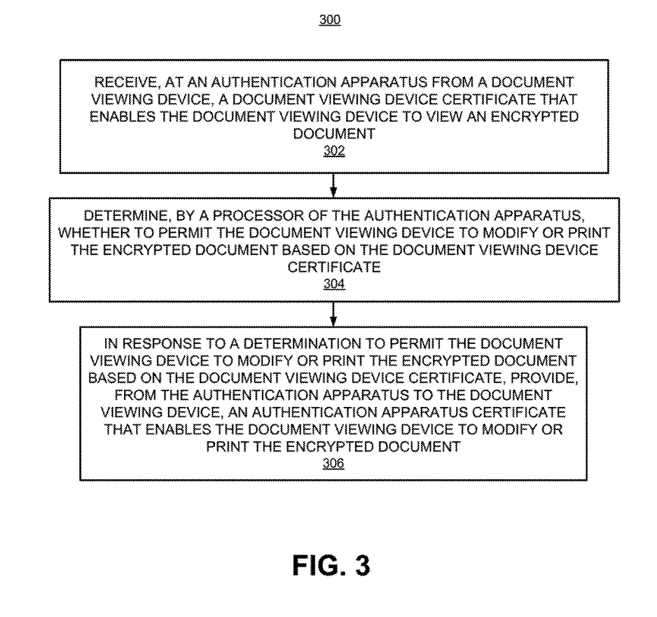

FIGS. 3, 4, and 5 respectively illustrate flowcharts of methods 300, 400, and 500 for multi-factor authentication based content management, corresponding to the example of the apparatus 100 whose construction is described in detail above. The methods 300, 400, and 500 may be implemented on the apparatus 100 with reference to FIGS. 1A, 1B, and 2 by way of example and not limitation. The methods 300, 400, and 500 may be practiced in other apparatus.

Referring to FIG. 3, for the method 300, at block 302, the method may include receiving, at an authentication apparatus from a document viewing device, a document viewing device certificate that enables the document viewing device to view an encrypted document. The document viewing device certificate may provide the document viewing device limited permission to view the encrypted document. For example, referring to FIGS. 1A, 1B, and 2, the apparatus 100 may receive from the document viewing device 104 a document viewing device certificate 122 that enables the document viewing device 104 to view the encrypted document 102. The document viewing device certificate 122 may provide the document viewing device 104 with limited permission to view the encrypted document 102.

At block 304, the method may include determining, by a processor of the authentication apparatus, whether to permit the document viewing device to modify or print the encrypted document based on the document viewing device certificate. For example, referring to FIGS. 1A, 1B, and 2, the certificate analysis module 112 may determine whether to permit the document viewing device 104 to modify or print the encrypted document 102 based on the document viewing device certificate 122.

At block 306, in response to a determination to permit the document viewing device to modify or print the encrypted document based on the document viewing device certificate, the method may include providing, from the authentication apparatus to the document viewing device, an authentication apparatus certificate that enables the document viewing device to modify or print the encrypted document. For example, referring to FIGS. 1A, 1B, and 2, in response to a determination to permit the document viewing device 104 to modify or print the encrypted document 102 based on the document viewing device certificate 122, the authentication apparatus certificate 120 (i.e., the multi-factor authentication based content management apparatus certificate 120) that enables the document viewing device 104 to modify or print the encrypted document 102 may be provided from the authentication apparatus 100 to the document viewing device 104.

According to an example, the method 300 may include receiving, at the authentication apparatus 100, the encrypted document 102 from the document viewing device 104. In response to the determination to permit the document viewing device 104 to modify or print the encrypted document 102 based on the document viewing device certificate 122, the method 300 may include decrypting, at the authentication apparatus 100, the encrypted document 102. In response to the determination to permit the document viewing device 104 to modify or print the encrypted document 102 based on the document viewing device certificate 122, the method 300 may include forwarding, from the authentication apparatus 100, the decrypted document 116 and the authentication apparatus certificate 120 that enables the document viewing device 104 to modify or print the decrypted document 116.

According to an example, the method 300 may include storing the document viewing device certificate 122 and the authentication apparatus certificate 120, and recording an event history related to the encrypted document 102 based on an identification of the document viewing device 104 based on the stored document viewing device certificate 122, an identification of the authentication apparatus 100 based on the stored authentication apparatus certificate 120, and the viewing, modification, and/or printing of the encrypted document 102.

According to an example, the method 300 may include utilizing the event history to determine a time, a location, and/or a user that is associated with the viewing, modification, and/or printing of the encrypted document 102.

According to an example, the method 300 may include utilizing the event history to determine a location that is associated with the viewing, modification, and/or printing of the encrypted document 102. The location may be based on a location beacon associated with the authentication apparatus 100.

According to an example, the method 300 may include storing the document viewing device certificate 122, the authentication apparatus certificate 120, and the printing device certificate 124 for a printing device 108 that enables printing of the encrypted document 102, and recording an event history related to the encrypted document 102 based on an identification of the document viewing device 104 based on the stored document viewing device certificate 122, an identification of the authentication apparatus 100 based on the stored authentication apparatus certificate 120, an identification of the printing device 108 based on the stored printing device certificate 124, and the viewing, modification, and/or printing of the encrypted document 102.

According to an example, the method 300 may include encrypting, at the authentication apparatus 100, the decrypted document 116, and forwarding, from the authentication apparatus 100, the encrypted document 102 to the document viewing device 104 to return to a document repository.

According to an example, for the method 300, receiving, at an authentication apparatus 100 from a document viewing device 104, a document viewing device certificate 122 that enables the document viewing device 104 to view an encrypted document 102 may further include receiving, at the authentication apparatus 100 from the document viewing device 104, the document viewing device certificate 122 of the document viewing device 104 that is disposed at less than a predetermined distance 106 from the authentication apparatus 100 without contact with the authentication apparatus 100, and determining the predetermined distance 106 based on RSSI values related to the authentication apparatus 100 and/or the document viewing device 104.

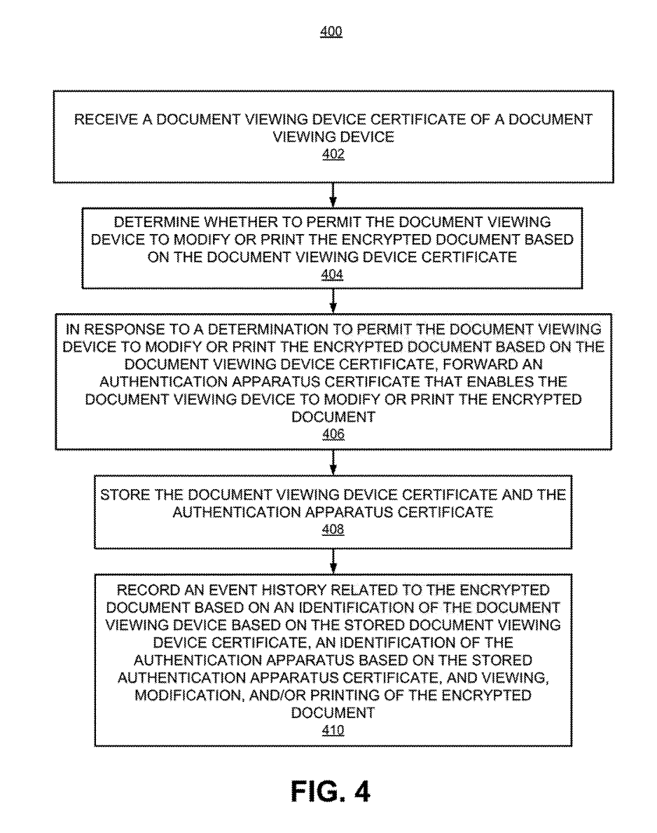

Referring to FIG. 4, for the method 400, at block 402, the method may include receiving a document viewing device certificate of a document viewing device. For example, referring to FIGS. 1A, 1B, and 2, the apparatus 100 may receive a document viewing device certificate 122 of a document viewing device 104. The document viewing device certificate 122 may enable the document viewing device 104 to view an encrypted document 102.

At block 404, the method may include determining whether to permit the document viewing device to modify or print the encrypted document based on the document viewing device certificate. For example, referring to FIGS. 1A, 1B, and 2, the certificate analysis module 112 may determine whether to permit the document viewing device 104 to modify or print the encrypted document 102 based on the document viewing device certificate 122.

At block 406, in response to a determination to permit the document viewing device to modify or print the encrypted document based on the document viewing device certificate, the method may include forwarding an authentication apparatus certificate that enables the document viewing device to modify or print the encrypted document. For example, referring to FIGS. 1A, 1B, and 2, in response to a determination to permit the document viewing device 104 to modify or print the encrypted document 102 based on the document viewing device certificate 122, an authentication apparatus certificate 120 that enables the document viewing device 104 to modify or print the encrypted document 102 may be forwarded to the document viewing device 104.

At block 408, the method may include storing the document viewing device certificate and the authentication apparatus certificate. For example, referring to FIGS. 1A, 1B, and 2, the certificate storage module 118 may provide for the storage of the document viewing device certificate 122 and the authentication apparatus certificate 120.

At block 410, the method may include recording an event history related to the encrypted document based on an identification of the document viewing device based on the stored document viewing device certificate, an identification of the authentication apparatus based on the stored authentication apparatus certificate, and viewing, modification, and/or printing of the encrypted document. For example, referring to FIGS. 1A, 1B, and 2, the event history tracking module 128 may record an event history related to the encrypted document 102 based on an identification of the document viewing device 104 based on the stored document viewing device certificate 122, an identification of the authentication apparatus 100 based on the stored authentication apparatus certificate 129, and viewing, modification, and/or printing of the encrypted document 102.

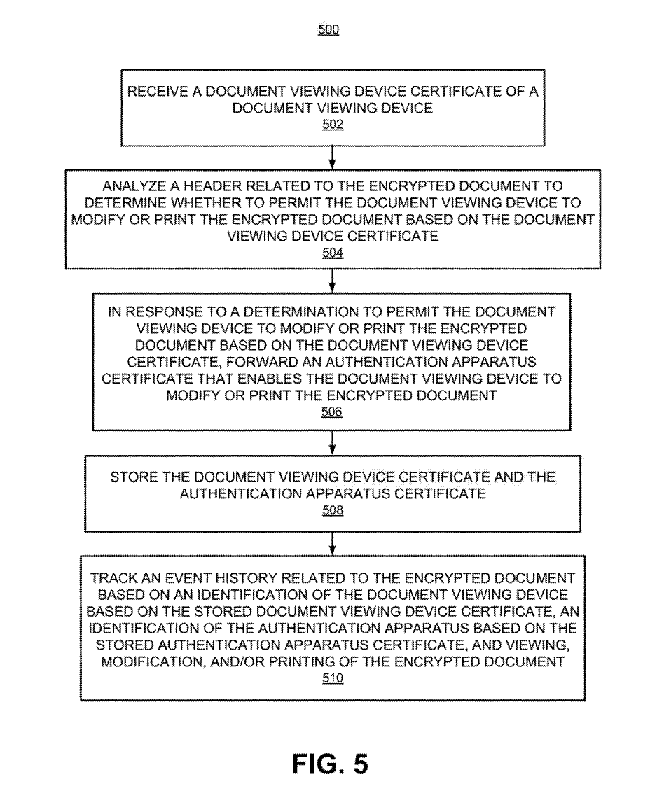

Referring to FIG. 5, for the method 500, at block 502, the method may include receiving a document viewing device certificate of a document viewing device. For example, referring to FIGS. 1A, 1B, and 2, the apparatus 100 may receive a document viewing device certificate 122 of a document viewing device 104. The document viewing device certificate may enable the document viewing device to view an encrypted document.

At block 504, the method may include analyzing a header related to the encrypted document to determine whether to permit the document viewing device to modify or print the encrypted document based on the document viewing device certificate. For example, referring to FIGS. 1A, 1B, and 2, the certificate analysis module 112 may analyze a header related to the encrypted document to determine whether to permit the document viewing device 104 to modify or print the encrypted document 102 based on the document viewing device certificate 122.

At block 506, in response to a determination to permit the document viewing device to modify or print the encrypted document based on the document viewing device certificate, the method may include forwarding an authentication apparatus certificate that enables the document viewing device to modify or print the encrypted document. For example, referring to FIGS. 1A, 1B, and 2, in response to a determination to permit the document viewing device 104 to modify or print the encrypted document 102 based on the document viewing device certificate 122, an authentication apparatus certificate 120 that enables the document viewing device 104 to modify or print the encrypted document 102 may be forwarded to the document viewing device 104.

At block 508, the method may include storing the document viewing device certificate and the authentication apparatus certificate. For example, referring to FIGS. 1A, 1B, and 2, the certificate storage module 118 may provide for the storage of the document viewing device certificate 122 and the authentication apparatus certificate 120.

At block 510, the method may include tracking an event history related to the encrypted document based on an identification of the document viewing device based on the stored document viewing device certificate, an identification of the authentication apparatus based on the stored authentication apparatus certificate, and viewing, modification, and/or printing of the encrypted document. For example, referring to FIGS. 1A, 1B, and 2, the event history tracking module 128 may record an event history related to the encrypted document 102 based on an identification of the document viewing device 104 based on the stored document viewing device certificate 122, an identification of the authentication apparatus 100 based on the stored authentication apparatus certificate 129, and viewing, modification, and/or printing of the encrypted document 102.

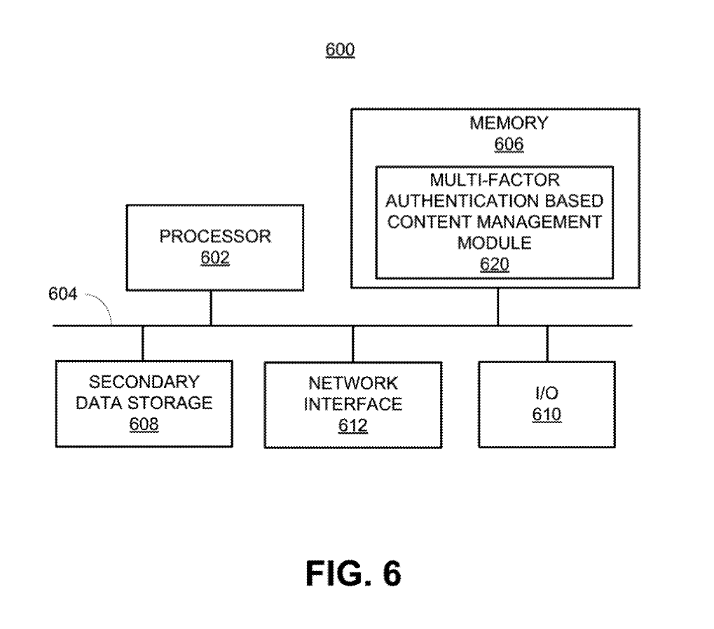

FIG. 6 shows a computer system 600 that may be used with the examples described herein. The computer system 600 may represent a generic platform that includes components that may be in a server or another computer system. The computer system 600 may be used as a platform for the apparatus 100. The computer system 600 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 600 may include a processor 602 that may implement or execute machine readable instructions performing some or all of the methods, functions and other processes described herein. Commands and data from the processor 602 may be communicated over a communication bus 604.

The computer system may also include a main memory 606, such as a random access memory (RAM), where the machine readable instructions and data for the processor 602 may reside during runtime, and a secondary data storage 608, which may be non-volatile and stores machine readable instructions and data. The memory and data storage are examples of computer readable mediums. The memory 606 may include a multi-factor authentication based content management module 620 including machine readable instructions residing in the memory 606 during runtime and executed by the processor 602. The multi-factor authentication based content management module 620 may include the modules of the apparatus 100 shown in FIGS. 1A-2.

The computer system 600 may include an I/O device 610, such as a keyboard, a mouse, a display, etc. The computer system may include a network interface 612 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for multi-factor authentication based content management, the method comprising:
receiving, at an authentication apparatus from a document viewing device, a document viewing device certificate that enables the document viewing device to view an encrypted document, wherein the document viewing device certificate provides the document viewing device limited permission to view the encrypted document;
determining, by a processor of the authentication apparatus, whether to permit the document viewing device to modify or print the encrypted document based on the document viewing device certificate; and
in response to a determination to permit the document viewing device to modify or print the encrypted document based on the document viewing device certificate, providing, from the authentication apparatus to the document viewing device, an authentication apparatus certificate that enables the document viewing device to modify or print the encrypted document.

2. The method of claim 1, further comprising:
receiving, at the authentication apparatus, the encrypted document from the document viewing device;
in response to the determination to permit the document viewing device to modify or print the encrypted document based on the document viewing device certificate, decrypting, at the authentication apparatus, the encrypted document; and
in response to the determination to permit the document viewing device to modify or print the encrypted document based on the document viewing device certificate, forwarding, from the authentication apparatus, the decrypted document and the authentication apparatus certificate that enables the document viewing device to modify or print the decrypted document.

3. The method of claim 1, further comprising:
storing the document viewing device certificate and the authentication apparatus certificate; and
recording an event history related to the encrypted document based on an identification of the document viewing device based on the stored document viewing device certificate, an identification of the authentication apparatus based on the stored authentication apparatus certificate, and at least one of viewing, modification, and printing of the encrypted document.

4. The method of claim 3, further comprising:
utilizing the event history to determine at least one of a time, a location, and a user that is associated with the at least one of viewing, modification, and printing of the encrypted document.

5. The method of claim 3, further comprising:
utilizing the event history to determine a location that is associated with the at least one of viewing, modification, and printing of the encrypted document, wherein the location is based on a location beacon associated with the authentication apparatus.

6. The method of claim 1, further comprising:
storing the document viewing device certificate, the authentication apparatus certificate, and a printing device certificate for a printing device that enables printing of the encrypted document; and
recording an event history related to the encrypted document based on an identification of the document viewing device based on the stored document viewing device certificate, an identification of the authentication apparatus based on the stored authentication apparatus certificate, an identification of the printing device based on the stored printing device certificate, and at least one of viewing, modification, and printing of the encrypted document.

7. The method of claim 1, wherein the authentication apparatus is a smart badge or a smart watch that is wearable by a user.

8. The method of claim 1, wherein the document viewing device is a smartphone, a tablet, or a personal computer that is to print the encrypted document using a printing device.

9. The method of claim 2, further comprising:
encrypting, at the authentication apparatus, the decrypted document; and
forwarding, from the authentication apparatus, the encrypted document to the document viewing device to return to a document repository.

10. The method of claim 1, wherein receiving, at an authentication apparatus from a document viewing device, a document viewing device certificate that enables the document viewing device to view an encrypted document further comprises:
receiving, at the authentication apparatus from the document viewing device, the document viewing device certificate of the document viewing device that is disposed at less than a predetermined distance from the authentication apparatus without contact with the authentication apparatus; and
determining the predetermined distance based on received signal strength indicator (RSSI) values related to at least one of the authentication apparatus and the document viewing device.

11. An authentication apparatus to perform multi-factor authentication based content management, the apparatus comprising:
a processor; and
a memory storing machine readable instructions that when executed by the processor cause the processor to:
receive a document viewing device certificate of a document viewing device, wherein the document viewing device certificate enables the document viewing device to view an encrypted document;
determine whether to permit the document viewing device to modify or print the encrypted document based on the document viewing device certificate;
in response to a determination to permit the document viewing device to modify or print the encrypted document based on the document viewing device certificate, forward an authentication apparatus certificate that enables the document viewing device to modify or print the encrypted document;
store the document viewing device certificate and the authentication apparatus certificate; and
record an event history related to the encrypted document based on an identification of the document viewing device based on the stored document viewing device certificate, an identification of the authentication apparatus based on the stored authentication apparatus certificate, and at least one of viewing, modification, and printing of the encrypted document.

12. The authentication apparatus according to claim 11, further comprising machine readable instructions to:
store the document viewing device certificate, the authentication apparatus certificate, and a printing device certificate for a printing device that enables printing of the encrypted document; and
record the event history related to the encrypted document based on the identification of the document viewing device based on the stored document viewing device certificate, the identification of the authentication apparatus based on the stored authentication apparatus certificate, an identification of the printing device based on the stored printing device certificate, and the at least one of viewing, modification, and printing of the encrypted document.

13. A non-transitory computer readable medium having stored thereon machine readable instructions to provide multi-factor authentication based content management, the machine readable instructions, when executed, cause a processor to:
receive a document viewing device certificate of a document viewing device, wherein the document viewing device certificate enables the document viewing device to view an encrypted document;
analyze a header related to the encrypted document to determine whether to permit the document viewing device to modify or print the encrypted document based on the document viewing device certificate;
in response to a determination to permit the document viewing device to modify or print the encrypted document based on the document viewing device certificate, forward an authentication apparatus certificate that enables the document viewing device to modify or print the encrypted document;
store the document viewing device certificate and the authentication apparatus certificate; and
track an event history related to the encrypted document based on an identification of the document viewing device based on the stored document viewing device certificate, an identification of an authentication apparatus based on the stored authentication apparatus certificate, and at least one of viewing, modification, and printing of the encrypted document.

14. The non-transitory computer readable medium according to claim 13, further comprising machine readable instructions to:
receive the encrypted document from the document viewing device;
in response to the determination to permit the document viewing device to modify or print the encrypted document based on the document viewing device certificate, decrypt the encrypted document; and
in response to the determination to permit the document viewing device to modify or print the encrypted document based on the document viewing device certificate, forward the decrypted document and the authentication apparatus certificate that enables the document viewing device to modify or print the decrypted document.

15. The non-transitory computer readable medium according to claim 14, further comprising machine readable instructions to:
encrypt the decrypted document; and
forward the encrypted document to the document viewing device to return to a document repository.
